(19) United States
(12) Patent Application Publication
(10) Pub. No.: US 2023/0134800 A1
(43) Pub. Date: May 4, 2023

(54) VANADIUM CELL SOC BALANCED SYSTEM

(71) Applicant: VRB ENERGY OPERATIONS (BEIJING) CO. LTD., Beijing (CN)

(72) Inventors: Bo HU, Beijing (CN); Mianyan HUANG, Beijing (CN); Chen ZHANG, Beijing (CN)

(21) Appl. No.: 18/051,478

(22) Filed: Oct. 31, 2022

(30) Foreign Application Priority Data
Nov. 2, 2021 (CN) 202111287458.6

(51) Int. Cl. H01M 8/18; H01M 8/04537; H01M 8/04858

(52) U.S. Cl. CPC H01M 8/18; H01M 8/04619; H01M 8/0494

(57) ABSTRACT

The application relates to a vanadium battery SOC balance system, which comprises a detection module, a control module, a load module and vanadium battery modules; the vanadium battery modules are connected in series; the detection module is used for detecting and outputting SOC values of the vanadium battery modules; the control module is connected with the detection module and used for receiving the SOC values and connecting the load module into one of the vanadium battery modules according to the SOC values. The detection module can detect the SOC values of the vanadium battery modules, the control module can insert a load into one of the vanadium battery modules according to the SOC values, the vanadium battery modules inserted into the load module can discharge through the load module, the SOC values of the vanadium battery modules are reduced, and the SOC values of the vanadium battery modules are balanced.

### RELATED APPLICATIONS

This application claims priority to and the benefit of Chinese Patent Application No. 202111287458.6 filed on Nov. 2, 2021, the disclosure of which is expressly incorporated herein by reference in its entirety.

### TECHNICAL FIELD

The application relates to the field of vanadium batteries, in particular to a vanadium battery SOC balance system.

### BACKGROUND

The vanadium battery is a storage battery and can store energy by utilizing different chemical potential energies of vanadium ions in different oxidation states. The vanadium battery has the advantages of high charging and discharging efficiency, recyclable electrolyte and the like.

It can be appreciated that a plurality of galvanic piles can be connected between a positive electrode electrolyte tank and a negative electrode electrolyte tank, and all galvanic piles are established ties and are together can improve battery capacity, and all galvanic piles are parallelly connected and are together can raise power, consequently adopt earlier the mode of establishing ties again parallelly connected to form the better battery of performance, nevertheless can make the pipeline loss great, and pipeline current increases simultaneously causes the galvanic pile to destroy easily. However, when the liquid path is disconnected, the cell is divided into several groups of parallel-connected cell stacks, and one positive electrolyte tank and one negative electrolyte tank are provided for each group of cell stacks, and after a long-time operation, the SOC may be unbalanced, thereby affecting the battery capacity.

### SUMMARY

In order to improve the problem of SOC unbalance, the application provides a vanadium battery SOC balance system.

The SOC balance system of the vanadium redox battery adopts the following technical scheme:

a vanadium battery SOC balance system comprises a detection module, a control module, a load module and a plurality of vanadium battery modules;

the vanadium battery modules are sequentially connected in series;

the detection module is used for detecting and outputting SOC values of the vanadium battery modules;

the control module is connected with the detection module and used for receiving the SOC values and connecting the load module into one of the vanadium battery modules according to the SOC values.

By adopting the technical scheme, the detection module can detect the SOC values of the vanadium battery modules, the control module can insert the load into one of the vanadium battery modules according to the SOC values, so that the vanadium battery module inserted into the load module can discharge through the load module, the SOC value of the vanadium battery module is further reduced, and the SOC values of the vanadium battery modules are balanced.

Optionally, the number of the vanadium redox battery modules is two, and the two vanadium redox battery modules are respectively a first vanadium redox battery module and a second vanadium redox battery module;

the first vanadium battery module is connected with the second vanadium battery module in series;

the detection module is used for detecting the SOC value of the first vanadium battery module and outputting an SOC1 value, and is used for detecting the SOC value of the second vanadium battery module and outputting an SOC2 value;

the control module is connected with the detection module and used for receiving the SOC1 value and the SOC2 value and connecting the load module into the first vanadium battery module or the second vanadium battery module according to the difference value of the SOC1 value and the SOC2 value.

Through adopting above-mentioned technical scheme, the detection module can detect the SOC value of first vanadium battery module and second vanadium battery module, and control module can insert the load into first vanadium battery module or second vanadium battery module according to the difference of SOC1 value and SOC2 value for first vanadium battery module and second vanadium battery module can discharge through the load module, and then reach that SOC1 value is close with SOC2 value, so that the SOC value of first vanadium battery module and second vanadium battery module is balanced.

Optionally, the load module is respectively connected in parallel to the first vanadium battery module and the second vanadium battery module, and loops of the load module connected with the first vanadium battery module and the second vanadium battery module are respectively provided with at least one controllable switch;

the control module is used for outputting a first closing signal when the difference value between the SOC1 value and the SOC2 value is larger than a first preset value, and outputting a second closing signal when the difference value between the SOC1 value and the SOC2 value is smaller than a second preset value;

the at least one controllable switch is positioned on a loop of the load module connected with the first vanadium battery module and is used for being closed when receiving a first closing signal;

and the at least one controllable switch positioned on the loop of the load module connected with the second vanadium battery module is used for closing when receiving a second closing signal.

By adopting the technical scheme, when the difference value between the SOC1 value and the SOC2 value is larger than a first preset value, the first vanadium battery module is connected to the load module to discharge. When the difference value between the SOC1 value and the SOC2 value is smaller than a second preset value, the second vanadium battery module is connected to the load module to discharge, so that the difference value between the SOC1 value and the SOC2 value is controlled within an allowable range, and the SOC is balanced.

Optionally, the first vanadium redox battery module and the second vanadium redox battery module both include a positive electrolyte tank, a negative electrolyte tank and a plurality of parallel electric stacks;

the anode electrolyte tank is respectively communicated with the anode and the cathode of each electric pile through pipelines, and the cathode electrolyte tank is respectively communicated with the anode and the cathode of each electric pile through pipelines;

the load module is connected in parallel with the electric pile of the first vanadium battery module and the electric pile of the second vanadium battery module.

Optionally, a loop of the load module connected to the first vanadium redox battery module and a loop of the load module connected to the second vanadium redox battery module have a common branch, and the at least one controllable switch located on the loop of the load module connected to the first vanadium redox battery module and the at least one controllable switch located on the loop of the load module connected to the second vanadium redox battery module form a double-pole double-throw controllable switch.

Optionally, the pipeline connected with the anode electrolyte tank and the pipeline connected with the cathode electrolyte tank are both provided with a circulating pump.

Through adopting above-mentioned technical scheme, the circulating pump can be with anodal electrolyte and negative pole electrolyte pump sending to each pile.

Optionally, the control module includes a processing unit and a control unit;

the processing unit is connected with the detection module and is used for receiving the SOC1 value and the SOC2 value, calculating the difference value of the SOC1 value and the SOC2 value and outputting the difference value of the SOC1 value and the SOC2 value;

the control unit is connected with the processing unit and used for receiving the difference value between the SOC1 value and the SOC2 value, outputting the first closing signal when the difference value between the SOC1 value and the SOC2 value is larger than the first preset value, and outputting the second closing signal when the difference value between the SOC1 value and the SOC2 value is smaller than the second preset value.

Optionally, a balance pipe is further connected between the positive electrode electrolyte tank and the negative electrode electrolyte tank in the first vanadium battery module and between the positive electrode electrolyte tank and the negative electrode electrolyte tank in the second vanadium battery module, and controllable balance valves are respectively arranged on the balance pipes;

the liquid level detection device is used for detecting the liquid level in each positive electrolyte tank and each negative electrolyte tank and outputting liquid level detection signals;

the control unit is also connected with a liquid level detection device, is used for receiving a liquid level detection signal and outputting a starting signal when the difference value of the liquid level values reflected by the liquid level detection signal is smaller than a difference preset value; the liquid level detection device is also used for outputting an adjusting signal when the difference value of the liquid level values reflected by the liquid level detection signal is greater than a difference preset value;

the controllable balance valve is connected with the control unit and is used for being opened when the adjusting signal is received;

the detection module is further used for detecting the first vanadium battery module and the second vanadium battery module when receiving a starting signal.

By adopting the technical scheme, when the liquid level difference between the positive electrolyte and the negative electrolyte is too large, the balance valve needs to be opened to balance the liquid levels of the positive electrolyte and the negative electrolyte, and then the SOC value of the first vanadium battery module and the SOC value of the second vanadium battery module are detected.

In summary, the present application includes at least one of the following beneficial technical effects:

1. the detection module can detect the SOC values of the first vanadium battery module and the second vanadium battery module, the control module can insert loads into the first vanadium battery module or the second vanadium battery module according to the difference value of the SOC1 value and the SOC2 value, the first vanadium battery module and the second vanadium battery module can discharge through the load module, the SOC1 value is close to the SOC2 value, and the SOC values of the first vanadium battery module and the second vanadium battery module are balanced.

Additional aspects and advantages will be apparent from the following detailed description of preferred embodiments, which proceeds with reference to the accompanying drawings.

### BRIEF DESCRIPTION OF THE DRAWINGS

FIG. 1 is a system schematic diagram of a vanadium redox battery SOC balancing system according to an embodiment of the present application.

FIG. 2 is a schematic circuit diagram of a vanadium redox battery SOC balancing system according to an embodiment of the present application.

FIG. 3 is another circuit schematic diagram of the vanadium redox battery SOC balancing system according to the embodiment of the present application.

### DETAILED DESCRIPTION OF PREFERRED EMBODIMENTS

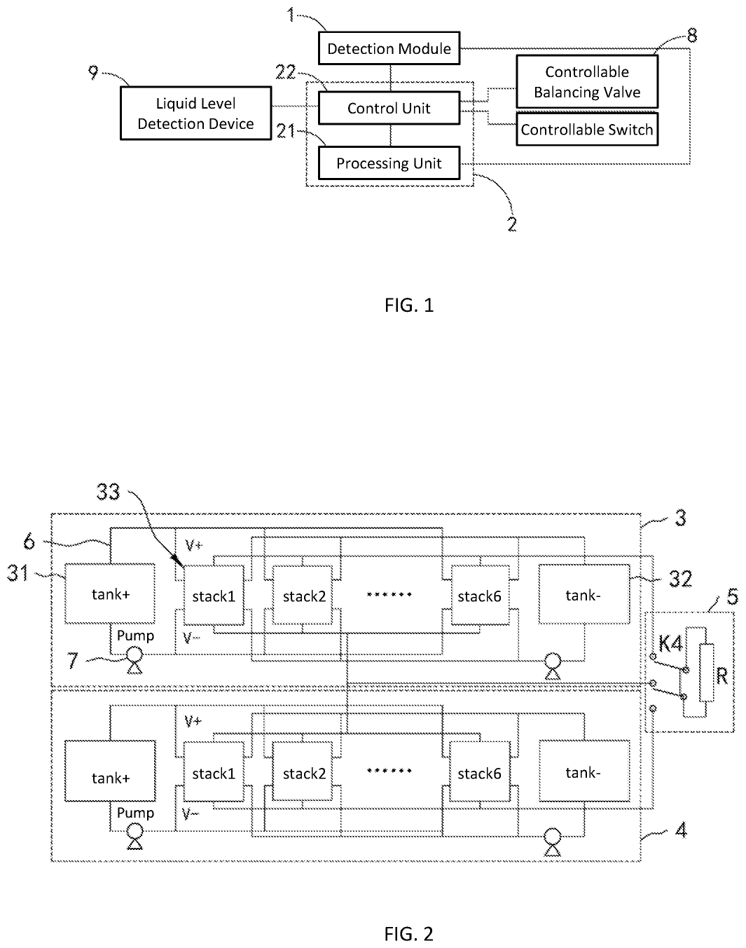

In order to make the objects, technical solutions and advantages of the present application more apparent, the present application is further described in detail below with reference to FIG. 1-3 and the embodiments. It should be understood that the specific embodiments described herein are merely illustrative of the present application and are not intended to limit the present application.

The embodiment of the application discloses a vanadium redox battery SOC balance system. Referring to FIGS. 1 and 2, the vanadium battery SOC balancing system includes a detection module 1, a control module 2, a load module 5, and a plurality of vanadium battery modules. The SOC values of the vanadium battery modules are detected through the detection module 1, so that the control module 2 can control the load module 5 to be connected into one of the vanadium battery modules according to the SOC values to consume the electric energy of the vanadium battery modules, and further the SOC values of the vanadium battery modules are balanced.

Specifically, two vanadium battery modules may be provided. When there are two vanadium battery modules in the vanadium redox battery SOC balance system of the present application, the two vanadium battery modules are a first vanadium battery module 3 and a second vanadium battery module 4, respectively, for the purpose of differentiation. Further, the detection module 1 detects the SOC values of the first vanadium battery module 3 and the second vanadium battery module, so that the control module 2 can control the first vanadium battery module 3 or the second vanadium battery module 4 to be connected to the load module 5 to consume electric energy according to the difference between the SOC values of the first vanadium battery module 3 and the second vanadium battery module 4, and further the SOC values of the first vanadium battery module 3 and the second vanadium battery module 4 are balanced.

The first vanadium battery module 3 is connected in series with the second vanadium battery module 4. The first vanadium redox battery module 3 and the second vanadium redox battery module 4 both comprise a positive electrolyte tank 31 and a negative electrolyte tank 32 and a plurality of parallel electric piles 33, and the two groups of parallel electric piles 33 are connected in series. Since the first vanadium battery module 3 and the second vanadium battery module 4 are connected in the same manner, the first vanadium battery module 3 is taken as an example in the embodiment of the present application.

The positive electrolyte tank 31 and the negative electrolyte tank 32 in the first vanadium redox battery module 3 are respectively communicated with the positive electrode and the negative electrode of each electric pile 33 through pipelines 6, and circulating pumps 7 are further arranged on the pipelines 6 communicated with the positive electrolyte tank 31 and the pipelines 6 communicated with the negative electrolyte tank 32, so that positive electrolyte can circulate between the positive electrolyte tank 31 and each electric pile 33, and similarly, negative electrolyte can circulate between the negative electrolyte tank 32 and each electric pile 33.

Moreover, a balance pipe is provided between the positive electrode electrolyte tank 31 and the negative electrode electrolyte tank 32, and the balance pipe enables the positive electrode electrolyte tank 31 and the negative electrode electrolyte tank 32 to be communicated. Of course, the balance pipe is further provided with a controllable balance valve 8, so that when the liquid level difference between the positive electrolyte tank 31 and the negative electrolyte tank 32 is large, the controllable balance valve 8 is controlled to open, so that the liquid levels in the positive electrolyte pipe and the negative electrolyte tank 32 are consistent.

The load modules 5 are respectively connected in parallel to the first vanadium battery module 3 and the second vanadium battery module 4. Specifically, the load module 5 includes load resistors R connected in parallel to the cell stacks 33 of the first vanadium battery module 3 and the cell stacks 33 of the second vanadium battery module 4, respectively. At least one controllable switch is respectively arranged on a loop of the load resistor R connected with the first vanadium battery module 3 and the second vanadium battery module 4. The load resistor R can be switched into the first vanadium battery module 3 or the second vanadium battery module 4 by controlling the closed state of these controllable switches.

It is worth noting that the number of controllable switches provided on the circuit where the load resistor R is connected to the first vanadium battery module 3 and the second vanadium battery module 4 depends on the connection manner of the load resistor R to the first vanadium battery module 3 and the second vanadium battery module 4. Wherein, a controllable switch or two controllable switches can be respectively arranged on the loop of the load resistor R connected with the first vanadium battery module 3 and the second vanadium battery module 4.

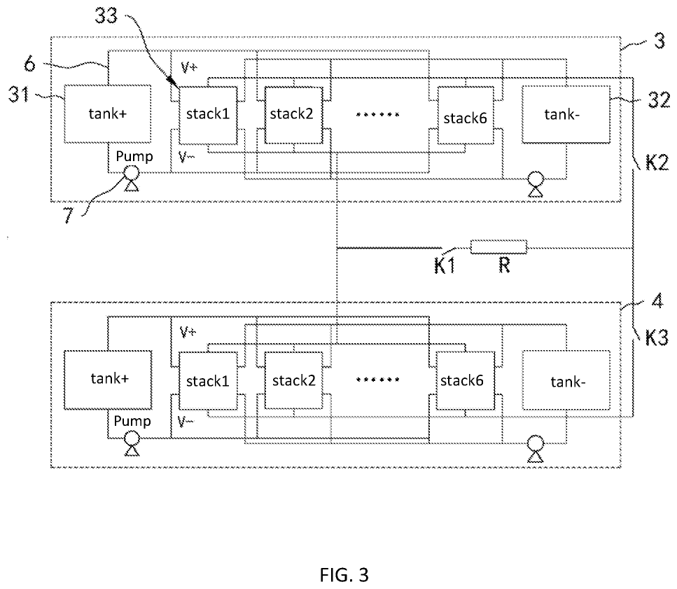

Referring to FIG. 3, in particular, a load resistor R is connected in series with a controllable switch K1, and the load resistor R and the controllable switch K1 are connected in parallel with the cell stack 33 in the first vanadium battery module 3 and the cell stack 33 in the second vanadium battery module 4, respectively. Meanwhile, a controllable switch K2 is further arranged on a branch of the first vanadium battery module 3 where the stack 33 is connected with the controllable switch K1 or a branch of the first vanadium battery module connected with the load resistor R. Similarly, a controllable switch K3 is further provided on the branch of the second vanadium battery module 4 where the stack 33 is connected to the controllable switch K1 or the branch connected to the load resistor R. Obviously, the controllable switch K1 and the controllable switch K2 are closed at the same time, and the controllable switch K3 is opened, so that the load resistor R is connected to the first vanadium battery module 3; accordingly, the controllable switch K1 and the controllable switch K3 are closed at the same time, and the controllable switch K2 is opened, so that the load resistor R is connected to the second vanadium battery module 4. Of course, the controllable switch K1, the controllable switch K2 and the controllable switch K3 are all turned off at the same time, i.e. the load resistor R is not switched in.

Referring to FIG. 2, further, in the present application, in addition to the branch where the load resistor R is located, the loops where the load resistor R is connected to the first vanadium battery module 3 and the second vanadium battery module 4 also have a common branch. Meanwhile, a controllable switch is respectively arranged on the loops of the load resistor R connected with the first vanadium battery module 3 and the second vanadium battery module 4. Preferably, the controllable switches respectively disposed on the loops connecting the load resistor R with the first vanadium battery module 3 and the second vanadium battery module 4 may be regarded as the same controllable switch K4, and the controllable switch K4 may be a double-pole double-throw switch. Specifically, two fixed ends of the controllable switch K4 are connected to both ends of the load resistor R, respectively. And a common branch and a loop of the load resistor R connected with the first vanadium battery module 3 and the second vanadium battery module 4 are provided with a connecting end except the common branch. Two movable ends of the controllable switch 4 can be connected with the connection ends on the common branch, and are connected with any connection end except the common branch on a loop where the load resistor R is connected with the first vanadium battery module 3 and the second vanadium battery module 4 to form a loop, so that the load resistor R is connected into the first vanadium battery module 3 or the second vanadium battery module 4. Of course, the two active ends of the controllable switch 4 are not connected to the three terminals, and then the load resistor R is not connected to the first vanadium battery module 3 and the second vanadium battery module 4.

Referring to FIGS. 1 and 2, generally, before SOC detection is performed on two sets of the positive electrolyte tank 31 and the negative electrolyte tank 32, it is first necessary to make the liquid levels in the two sets of the positive electrolyte tank 31 and the negative electrolyte tank 32 uniform. Therefore, the vanadium redox battery SOC balance system of the application also comprises a liquid level detection device 9.

The liquid level detection device 9 is used for detecting the liquid level in each positive electrolyte tank 31 and each negative electrolyte tank 32 and outputting a liquid level detection signal. Preferably, the liquid level detection device 9 is a liquid level sensor. Of course, a measuring instrument having a function of measuring a liquid level, such as a liquid level meter, may also be employed.

The control module 2 is connected with the liquid level detection device 9, is used for receiving the liquid level detection signal and outputting a starting signal when the difference value of the liquid level values reflected by the liquid level detection signal is smaller than the preset difference value; and the liquid level detection circuit is also used for outputting an adjusting signal when the difference value of the liquid level values reflected by the liquid level detection signal is greater than the preset difference value. Wherein the control module 2 comprises a processing unit 21 and a control unit 22.

The control unit 22 is connected with the liquid level detection device 9, and is used for receiving the liquid level detection signal and outputting a starting signal when the difference value of the liquid level values reflected by the liquid level detection signal is smaller than the preset difference value; and the liquid level detection circuit is also used for outputting an adjusting signal when the difference value of the liquid level values reflected by the liquid level detection signal is greater than the preset difference value.

It should be noted that before SOC detection is performed on the two sets of the positive electrolyte tank 31 and the negative electrolyte tank 32, the liquid level difference between the two sets of the positive electrolyte tank 31 and the negative electrolyte tank 32 may be zero, may be smaller, and may be larger. In general, it is allowable that the initial difference between the liquid level values of the two sets of the positive electrolyte tank 31 and the negative electrolyte tank 32 is small, i.e. the later operation such as SOC balancing is not greatly affected. Therefore, when the difference value of the liquid level values reflected by the liquid level detection signals is smaller than the preset difference value, the control unit 22 can output a start signal. Specifically, the liquid level difference is a difference between the liquid levels of the positive electrode electrolyte tank 31 and the negative electrode electrolyte tank 32 of the same group. In the present application, the difference preset value is 20 cm. Of course, the preset value of the difference value can be adaptively adjusted according to actual conditions.

The controllable balancing valve 8 is connected to the control unit 22 for receiving the adjustment signal and is opened upon receipt of the adjustment signal. At this time, the positive electrode electrolyte tank 31 and the negative electrode electrolyte tank 32 of the same group are communicated, and the liquid in one electrolyte tank with a higher liquid level flows to the other electrolyte tank, so that the liquid levels of the two electrolyte tanks are the same. When the adjustment of the liquid in the two electrolyte tanks is completed, the controllable balance valve 8 is closed. Specifically, the liquid levels of the positive electrolyte tank 31 and the negative electrolyte tank 32 may be detected by the liquid level detection device 9, and when the liquid phases of the positive electrolyte tank 31 and the negative electrolyte tank 32 are the same, the control unit 22 controls the controllable balance valve 8 to close. Of course, it is also possible to set the opening time for the controllable balance valve 8, and after the control unit 22 controls the controllable balance valve 8 to open, and after the controllable balance valve 8 is opened for a preset time period, the controllable balance valve 8 is automatically closed. The above description provides only two control methods as references, and does not limit other control methods. Accordingly, the control unit 22 outputs an activation signal after the controllable balancing valve 8 has closed.

The detection module 1 is connected to the control unit 22, and is configured to receive a start signal, and detect the first vanadium battery module 3 and the second vanadium battery module 4 when receiving the start signal. Specifically, the detection module 1 is used for detecting the SOC value of the first vanadium battery module 3 and outputting an SOC1 value; and is used for detecting the SOC value of the second vanadium battery module 4 and outputting the SOC2 value. It should be noted that the detection module 1 cannot directly detect the SOC1 value of the first vanadium battery module 3 and the SOC2 value of the second vanadium battery module 4, so that the detection module 1 actually detects the open-circuit voltage, i.e., OCV, between the two poles of the first vanadium battery module 3 or the second vanadium battery module 4, and further converts the open-circuit voltage into a corresponding SOC value.

Further, the processing unit 21 is connected to the detection module 1, and is configured to receive the SOC1 value and the SOC2 value, calculate a difference between the SOC1 value and the SOC2 value, and output a difference between the SOC1 value and the SOC2 value.

The control unit 22 is connected to the processing unit 21, and is configured to receive a difference between the SOC1 value and the SOC2 value, and to output a first closing signal when the difference between the SOC1 value and the SOC2 value is greater than a first preset value, and to output a second closing signal when the difference between the SOC1 value and the SOC2 value is less than a second preset value. The first closing signal is used for controlling at least one controllable switch on a loop connecting the load resistor R and the first vanadium battery module 3 to be closed and other controllable switches to be opened, and the second closing signal is used for controlling at least one controllable switch on a loop connecting the load resistor R and the second vanadium battery module 4 to be closed and other switches to be opened.

It can be understood that the difference between the SOC1 value and the SOC2 value is greater than the first preset value, which indicates that the SOC1 value of the first vanadium battery module 3 is greater than the SOC2 value of the second vanadium battery module 4, and the difference between the SOC1 value and the SOC2 value is greater than the first preset value. At this time, the control unit 22 needs to control at least one controllable switch on the loop where the load resistor R is connected with the first vanadium battery module 3 to be closed, and simultaneously control other controllable switches to be opened, so that the load resistor R is connected to the first vanadium battery module 3 to consume the energy of the first vanadium battery module 3 through the load resistor R, thereby reducing the SOC1 value.

Similarly, the difference between the SOC1 value and the SOC2 value is smaller than the second preset value, which can indicate that the SOC1 value of the first vanadium battery module 3 is smaller than the SOC2 value of the second vanadium battery module 4, and the difference between the SOC1 value and the SOC2 value is smaller than the second preset value, where it should be noted that the second preset value is a negative number. At this time, the control unit 22 needs to control at least one controllable switch on the loop connecting the load resistor R and the second vanadium battery module 4 to be closed, and simultaneously control other controllable switches to be opened, so that the load module 5 is connected to the second vanadium battery module 4 to consume the energy of the second vanadium battery module 4 through the load resistor R, thereby reducing the SOC2 value, and achieving the effect of balancing the SOC values of the first vanadium battery module 3 and the second vanadium battery module 4.

Besides, when the difference between the SOC1 value and the SOC2 value is greater than the second preset value and less than the first preset value, it indicates that the difference between the SOC1 value of the first vanadium battery module 3 and the SOC2 value of the second vanadium battery module 4 is within the allowable range. At this time, the control unit 22 controls all the controllable switches to be turned off so that the load resistor R is not connected into the first vanadium battery module 3 and the second vanadium battery module 4.

In the present application, the first preset value is 2%, and the second preset value is −2%, and of course, the first preset value and the second preset value can be adaptively designed according to actual situations. The liquid level detection process, the SOC detection process and the SOC balance process are processes of starting and preprocessing stages of the vanadium battery SOC balance system.

Further, after the SOC balancing system enters a normal operating state, the first preset value is changed to 5%, and the second preset value is changed to −5%, that is, when the difference between the SOC1 value and the SOC2 value is greater than 5%, the load resistor R is connected to the first vanadium battery module 3, when the difference between the SOC1 value and the SOC2 value is less than −5%, the load resistor R is connected to the second vanadium battery module 4, and when the difference between the SOC1 value and the SOC2 value is greater than −5% and less than 5%, the connection state of the load resistor R with the first vanadium battery module 3 and the second vanadium battery module 4 is maintained.

In addition, in the art, the detection module 1 and the control module 2 generally employ an EMS controller.

When there are three or more vanadium battery modules in the vanadium battery SOC balance system of the present application, the difference from the vanadium battery SOC balance system having two vanadium battery modules is only that: and the vanadium battery modules are sequentially connected in series. Similarly, the parallel electric stacks in each vanadium battery module are connected together in series in sequence.

At this time, load resistors R are respectively connected in parallel to the cell stacks of each vanadium battery module. And at least two controllable switches are respectively arranged on a loop of the load resistor R connected with each vanadium battery module. The load resistor R can be connected to one of the vanadium battery modules by controlling the closed state of the controllable switches. The connection mode of the load resistor R and the plurality of vanadium battery modules can refer to the connection mode of the load resistor R and the first vanadium battery module 3 and the second vanadium battery module 4. It is worth mentioning that the controllable switch in series with the load resistor R is a common controllable switch in the loop where the load resistor R is connected to each vanadium battery module.

The processing unit 21 is configured to receive all the SOC values, compare all the SOC values to determine a maximum SOC value and a minimum SOC value, and then calculate and output a difference between the maximum SOC value and the minimum SOC value.

The control unit 22 is configured to receive a difference between the maximum SOC value and the minimum SOC value, and output a third close signal when the difference is greater than a first preset value. The third closing signal is used for controlling the two controllable switches on a loop, connected with the load resistor R, of the vanadium battery module corresponding to the maximum SOC value to be closed, and simultaneously controlling the other controllable switches to be opened, so that the load resistor R is connected to the vanadium battery module corresponding to the maximum SOC value, the energy of the vanadium battery module is consumed through the load resistor R, and the SOC value of the vanadium battery module is reduced.

And when the difference value between the maximum SOC value and the minimum SOC value is smaller than the first preset value, the difference value of the SOC values of any two vanadium battery modules is in an allowed range. At this time, the control unit 22 controls all the controllable switches to be turned off, so that the load resistor R is not connected into any vanadium battery module.

Similarly, when the SOC balancing system enters a normal operating state, the first preset value is changed to 5%, that is, the difference between the maximum SOC value and the minimum SOC value is greater than 5%, the load resistor R is connected to the vanadium battery module corresponding to the maximum SOC value, and when the difference between the maximum SOC value and the minimum SOC value is less than 5%, the connection state between the load resistor R and the vanadium battery modules is maintained.

The implementation principle of the SOC balance system of the vanadium redox battery in the embodiment of the application is as follows: and simultaneously connecting the load module 5 with a plurality of vanadium battery modules, and arranging a controllable switch on a loop of the load module 5 connected with each vanadium battery module. The SOC values of the vanadium battery modules are detected through the detection module 1, and the control module 2 accesses the load module 5 into one of the vanadium battery modules according to the SOC values, so that the vanadium battery modules can consume energy through the load module 5, and further SOC value balance is achieved.

The foregoing is a preferred embodiment of the present application and is not intended to limit the scope of the application in any way, and any features disclosed in this specification (including the abstract and drawings) may be replaced by alternative features serving equivalent or similar purposes, unless expressly stated otherwise. That is, unless expressly stated otherwise, each feature is only an example of a generic series of equivalent or similar features.

It will be obvious to those having skill in the art that many changes may be made to the details of the above-described embodiments without departing from the underlying principles of the invention. The scope of the present invention should, therefore, be determined only by the following claims.

What is claimed is:

1. A vanadium battery SOC balancing system, comprising a detection module, a control module, a load module and multiple vanadium battery modules;
the multiple vanadium battery modules are series-connected in sequence;
the detection module is configured to detect and output SOC values of the multiple vanadium battery modules;
the control module is connected to the detection module, and configured to receive the multiple SOC values, and connect the load module to one of the multiple vanadium battery modules according to the sizes of the multiple SOC values.

2. The vanadium battery SOC balancing system as claimed in claim 1, wherein two of the vanadium battery modules are provided, being a first vanadium battery module and a second vanadium battery module respectively;
the first vanadium battery module and second vanadium battery module are connected in series;
the detection module is configured to detect an SOC value of the first vanadium battery module and output an SOC1 value, and configured to detect an SOC value of the second vanadium battery module and output an SOC2 value;
the control module is connected to the detection module, and configured to receive the SOC1 value and SOC2 value, and connect the load module to the first vanadium battery module or second vanadium battery module according to the difference between the SOC1 value and SOC2 value.

3. The vanadium battery SOC balancing system as claimed in claim 2, wherein the load module is separately connected in parallel with the first vanadium battery module and second vanadium battery module, and circuits connecting the load module to the first vanadium battery module and second vanadium battery module are respectively provided with at least one controllable switch;
the control module is configured to output a first closure signal when the difference between the SOC1 value and SOC2 value is greater than a first preset value, and configured to output a second closure signal when the difference between the SOC1 value and SOC2 value is less than a second preset value;
the at least one controllable switch located on the circuit connecting the load module to the first vanadium battery module is configured to close when the first closure signal is received;
the at least one controllable switch located on the circuit connecting the load module to the second vanadium battery module is configured to close when the second closure signal is received.

4. The vanadium battery SOC balancing system as claimed in claim 3, wherein the first vanadium battery module and second vanadium battery module each comprise a positive electrode electrolyte tank, a negative electrode electrolyte tank and multiple parallel-connected stacks;
the positive electrode electrolyte tank is in communication with a positive electrode and a negative electrode of each stack separately via a pipeline, and the negative electrode electrolyte tank is in communication with the positive electrode and negative electrode of each stack separately via a pipeline;
the load module is connected in parallel with the stacks of the first vanadium battery module and the stacks of the second vanadium battery module.

5. The vanadium battery SOC balancing system as claimed in claim 4, wherein the circuit connecting the load module to the first vanadium battery module and the circuit connecting the load module to the second vanadium battery module have a common branch, and the at least one controllable switch located on the circuit connecting the load module to the first vanadium battery module and the at least one controllable switch located on the circuit connecting the load module to the second vanadium battery module form a double-pole double-throw controllable switch.

6. The vanadium battery SOC balancing system as claimed in claim 5, wherein the pipeline connected to the positive electrode electrolyte tank and the pipeline connected to the negative electrode electrolyte tank are each provided with a circulating pump.

7. The vanadium battery SOC balancing system as claimed in claim 6, wherein the control module comprises a processing unit and a control unit;
the processing unit is connected to the detection module, configured to receive the SOC1 value and SOC2 value, configured to compute the difference between the SOC1 value and SOC2 value, and configured to output the difference between the SOC1 value and SOC2 value;
the control unit is connected to the processing unit (21), configured to receive the difference between the SOC1 value and SOC2 value, and configured to output the first closure signal when the difference between the SOC1 value and SOC2 value is greater than the first preset value, and configured to output the second closure signal when the difference between the SOC1 value and SOC2 value is less than the second preset value.

8. The vanadium battery SOC balancing system as claimed in claim 7, wherein balancing pipes are further connected between the positive electrode electrolyte tank and negative electrode electrolyte tank in the first vanadium battery module and between the positive electrode electrolyte tank and negative electrode electrolyte tank in the second vanadium battery module, and a controllable balancing valve is provided on each of the balancing pipes;
the system further comprises a liquid level detection device, the liquid level detection device being configured to detect a liquid level in each positive electrode electrolyte tank and each negative electrode electrolyte tank, and output liquid level detection signals;
the control unit is further connected to the liquid level detection device, configured to receive the liquid level detection signals, and configured to output an activation signal when the difference between liquid level values reflected by the liquid level detection signals is less than a difference preset value; and configured to output a regulation signal when the difference between liquid level values reflected by the liquid level detection signals is greater than a difference preset value;
the controllable balancing valve is connected to the control unit, and configured to open when the regulation signal is received;
the detection module is further configured to subject the first vanadium battery module and second vanadium battery module to detection when the activation signal is received.
